(19) United States
(12) Patent Application Publication
(10) Pub. No.: US 2009/0271004 A1
(43) Pub. Date: Oct. 29, 2009

(54) METHOD AND APPARATUS FOR RANGING DETECTION OF GESTURES

(76) Inventors: Reese Zecchin, Los Gatos, CA (US); Brendan Nystedt, Los Gatos, CA (US); Spencer Sands, Los Gatos, CA (US); Maurice Bizzarri, Palo Alto, CA (US); William C. Cross, Santa Clara, CA (US)

Correspondence Address: GLENN PATENT GROUP, 3475 EDISON WAY, SUITE L, MENLO PARK, CA, 94025, US

(21) Appl. No.: 12/430,695

(22) Filed: Apr. 27, 2009

Related U.S. Application Data
(60) Provisional application No. 61/048,515, filed on Apr. 28, 2008.

(51) Int. Cl. G05B 15/02; H04L 9/32; G06F 21/00; G05B 11/01

(52) U.S. Cl. 700/13; 700/83; 726/19

(57) ABSTRACT

In order for a user to control a machine using hand gestures, free of any contact with the machine, an apparatus generates one or more electromagnetic field, employing receivers to measure an electromagnetic signature caused by gestures of a person's hand within the electromagnetic field. The gestures include variations of hand position, proximity, configuration, and movement. For each measured signature, the apparatus cross-references the electromagnetic signature in a predetermined library to identify a corresponding predefined machine-readable input. Ultimately, the apparatus controls a designated machine pursuant to the person's hand gestures by transmitting the identified input to the machine.

### CROSS-REFERENCE TO RELATED APPLICATIONS

This application claims the benefit of the following earlier-filed foreign application in accordance 35 USC 119: U.S. Application 61/048,515, filed Apr. 28, 2008 in the names of Zecchin, Nystedt and Sands, and entitled RANGING DETECTION OF GESTURES. We hereby incorporate the entirety of the foregoing application herein by reference.

### BACKGROUND OF THE INVENTION

1. Field of the Invention

The invention relates to a computing machine that enables a person to control this or a different machine using hand gestures.

2. Description of the Related Art

The human-machine interface is one of the most challenging aspects of designing machinery today. Humans like to communicate by speaking or writing their thoughts and instructions. In contrast, computers and other machines are designed to receive input that is generated mechanically by pressing buttons, turning dials, typing on a keyboard, and other machine-readable activities.

Historically, the primary tools for people to interact with computers have been the keyboard and mouse. These technologies have been around since the 1950s. The mouse came into widespread use in the early 1980s. With the passage of time, however, the mouse has undergone little change. Of course, designers have added features to the mouse such as wheels, trackballs, optical sensors, and the like. But the fundamental technology remains the same—moving a cursor by rolling a ball. The progression of the mouse contrasts sharply with the staggering advancement of the rest of the computer industry. Processor speed has leaped from over one thousand percent in recent years, from 2 MHz to more than 2 GHz.

At any rate, the mouse is a counterintuitive solution, as this interface seeks to control a two-dimensional vertical plane by using a two-dimensional horizontal plane. Furthermore, the baby boomer generation is getting older, and with age comes certain physical limitations that make mouse use even more difficult to operate. Many handicapped people find it nearly impossible to use a computer mouse.

As an alternative to the mouse and other hand-operated interface devices, some research has focused on non-contact computer interfaces. In many of these systems, cameras are used to track movement of the human body. These systems have a number of limitations, however. They require sophisticated, processor intensive software to interpret the constant stream of data produced by the cameras. Costs can run high, too, since these systems typically use multiple cameras and specialized translation hardware, and require enormous input bandwidth and computational processing power. Furthermore, recognizing bodily movements can be difficult without constraining the background scene and activity, and providing adequate illumination. These restrictions are not practical in all environments.

And from a personal security standpoint, many users fear these cameras and their unblinking electric eyes. In many security sensitive environments, webcams are banned to protect at-risk material and operations, rendering these camera-based non-contact computer interfaces inoperable.

Consequently, these known systems are not entirely adequate for all applications, due to various unsolved problems.

### SUMMARY OF THE INVENTION

In order for a user to control a machine using hand gestures, free of any contact with the machine, an apparatus generates one or more electromagnetic fields, employing receivers to measure an electromagnetic signature caused by gestures of a person's hand within the electromagnetic field. The gestures include variations of hand position, proximity, configuration, and movement. For each measured signature, the apparatus cross-references the electromagnetic signature in a predetermined library to identify a corresponding predefined machine-readable input. Ultimately, the apparatus controls a designated machine pursuant to the person's hand gestures by transmitting the identified input to the machine.

In a different embodiment, rather than interpreting gestures for machine control, the apparatus is implemented to regulate the operation of a designated appliance according to prescribed safety criteria. The receivers are employed to measure electromagnetic signatures caused by presence of a person's hand in the electromagnetic field. The apparatus evaluates the electromagnetic signature to determine if the person's hand occupies a prescribed position relative to the appliance generally or a feature of the appliance, or if the person's hand is smaller than a prescribed minimum size. If the answer is YES, then the apparatus disables the appliance. Thus, the apparatus implements a safety feature by disabling the appliance when the user's hand gets too close, or when a child is trying to operate the appliance. Further embodiments include applications such as biometric security verification, controlling machines in sterile or contaminant-free or sanitary environment, controlling a wireless telephone, and many more.

### BRIEF DESCRIPTION OF THE DRAWINGS

FIG. 1A is a block diagram of the components and interconnections of a system for controlling a machine using hand gestures according to one embodiment of the invention

FIG. 1B is an illustration of an exemplary receiver configuration according to one embodiment of the invention.

FIG. 2 is a block diagram of a digital data processing machine according to one embodiment of the invention.

FIG. 3 shows an exemplary storage medium according to one embodiment of the invention.

FIG. 4 is a perspective view of exemplary logic circuitry according to one embodiment of the invention.

FIG. 5 is a flowchart of operations for controlling a machine using hand gestures according to one embodiment of the invention.

FIG. 6 is a flowchart of training operations according to one embodiment of the invention.

FIG. 7 is a flowchart of operations to define new gestures according to one embodiment of the invention.

FIG. 8 is a side view of various hand gestures according to one embodiment of the invention.

FIG. 9 is a perspective view of various movement axes according to one embodiment of the invention.

FIG. 10 is a table showing library contents according to one embodiment of the invention.

### DETAILED DESCRIPTION

The nature, objectives, and advantages of the invention will become more apparent to those skilled in the art after considering the following detailed description in connection with the accompanying drawings.

### Hardware Components and Interconnections

### Overall Structure

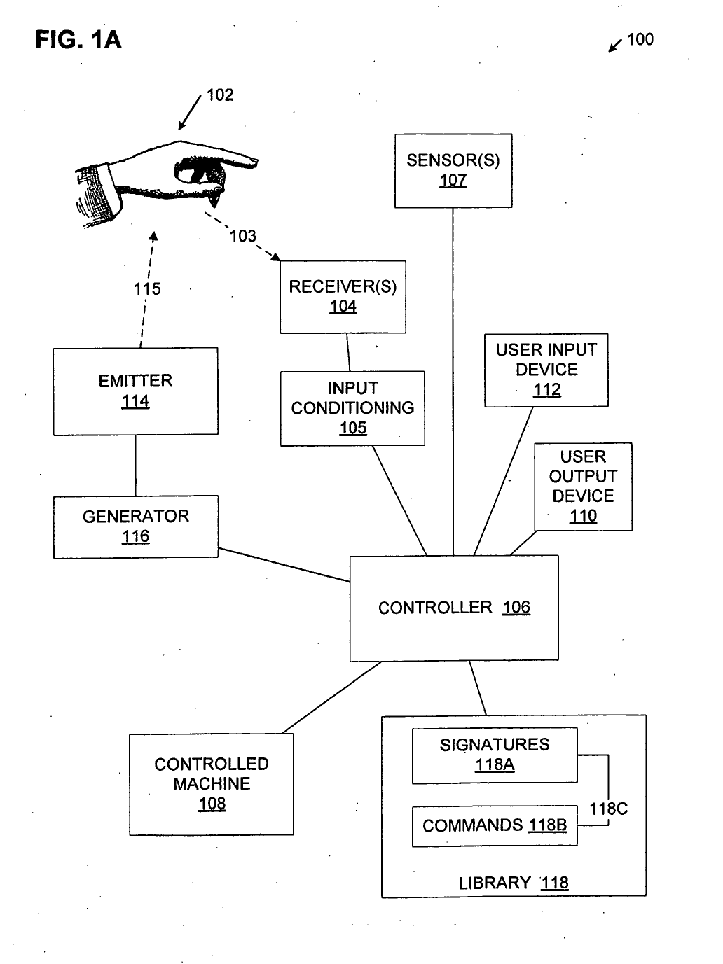

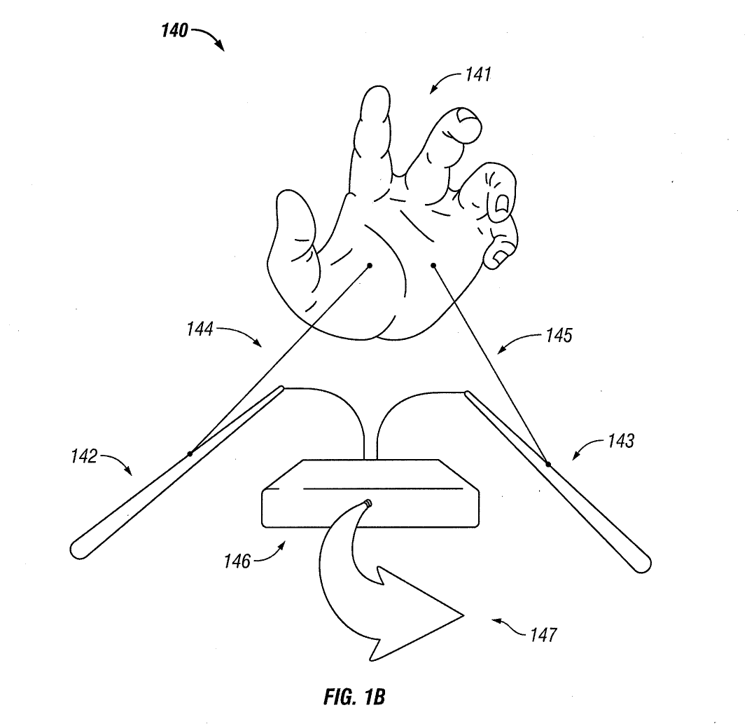

FIG. 1A shows a system for controlling a machine using hand gestures. Broadly, a controller 106 and various attached components form a system 100 that controls a designated machine 108 in accordance with gestures of a user's hand 102.

The designated machine 108, also called the “controlled machine,” may take a variety of forms, depending upon the ultimate application of the system 100. In one example, the machine 108 is a general purpose computer. In another example, the machine 108 is a computer controlled device with a dedicated purpose, such as a digital x-ray viewer, GPS navigation unit, cash register, kitchen appliance, or other such machine appropriate to the present disclosure. In another example, the machine 108 is a completely mechanical device and an interface (not shown) receives machine-readable instructions from the controller 106 and translates them into required mechanical input of the machine 108, such as pushing a button, turning a crank, operating a pulley, rotating a bell crank, and the like. In a further example, a single computer may serve as the controlled machine 108 and the controller 106, in which case this computer receives and processes gestures as its own input. This disclosure describes many more implementations of the machine 108, as explained below.

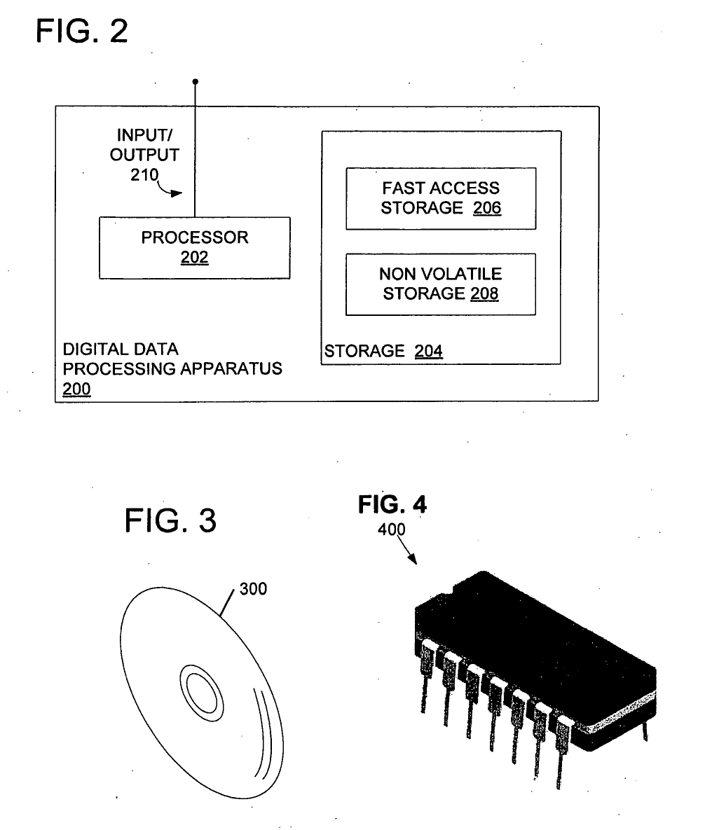

The controller 106 is a digital data processor, and may be implemented by one or more hardware devices, software devices, a portion of one or more hardware or software devices, or a combination of the foregoing. FIGS. 2-4 and the discussion below provide some more detailed examples of the controller 106. As a specific example, the controller 106 may employ a capacitance to digital converter circuit such as Analog Devices™ model AD7746.

As further shown in FIG. 1A, the controller 106 is coupled to various other components. There are one or more emitters 114, which collectively generate an electromagnetic or other field 115, referenced herein as an “e-field”. In one example, each emitter 114 is a flat plate. In other examples, each emitter 114 is cylindrically shaped, as a rod, mesh, sphere, cone, or bar.

Each emitter 114 operates under control of a generator 116, which contains electronics for generating the e-fields of desired amplitude, frequency, phase, and other electrical properties. In one example, the generators 116 run three emitters 114 under three different frequencies so as to avoid interfering with each other and to permit positional triangulation of bodies within the field 115. As an example, there may be one generator for each emitter. In one implementation, each generator includes an oscillator using a crystal control circuit in a phase locked loop. In a different example, the system 100 may use one relatively large emitter 114 for the entire system 100.

One or more receivers 104 sense properties 103 or changes in properties of the e-field 115 generated by the emitters 114. The sensing of these properties 103, in one example, involves measuring capacitive coupling between the emitter 114 and receiver 104. However, this arrangement may employ other principles such as inductance, heterodyning, and the like. In a specific example, there is a single lower emitter 114 and two side receivers 104, as depicted in FIG. 1B and explained further below. The receivers may be disposed in a three-dimensional arrangement or configured to be totally flat. More receivers can be added to suit the sensitivity, and depending on the application. To suit the particular application at hand, the receivers 104 may be placed beneath a keyboard 112, inside a kiosk, inside a bezel about a display monitor, or other such locations.

Output from the receivers 104 proceeds to an input conditioning unit 105, which contains electronics to process the raw receiver input and effectively sense a presence of the hand 102 or hands within the fields 115. More specifically, the conditioning unit 105 uses the output of the receivers 104 to generate an electromagnetic signature, referenced herein as a “signature.” The signature mathematically represents any or all of presence, configuration, movement, and other such properties of the hand 102 in the field 115. Depending upon the implementation, the signature may correspond to various electromagnetic properties, and may correspond to a measurement of voltage, current, inductance, capacitance, electrical resistance, EMF, electric power, electric field strength, magnetic field strength, magnetic flux, magnetic flux density, and the like. The term “electromagnetic” is used broadly herein, without any intended limitation.

If the output of the conditioning unit 105 occurs in analog form, an analog-to-digital converter (not shown) is imposed between the unit 105 and the controller 106. As an alternative to the conditioning unit 105 itself, an analog-to-digital converter (not shown) may be coupled between the receivers 104 and the controller 106, in which case the controller 106 computationally performs the tasks of the input conditioning unit 105. In another example, the controller 106 employs a capacitance to digital converter circuit such as Analog Devices™ model AD7746, which performs the input conditioning tasks, so the separate unit 105 can be omitted.

Optionally, the system 100 may employ various sensors 107, such as a camera, stereo cameras, humidity sensor, or other device to sense a physical property. The humidity sensor comprises a device for sensing humidity of the ambient air and providing an machine-readable output to the controller 106. Some examples of appropriate devices include a first-pulse generating circuit utilizing electrostatic capacitance or a porous silicon circuit. Other examples include a hygrometer, psychrometer, electric hygrometer, capacitive humidity sensor, or others. Some examples include the VAISALA™ humidity sensors models HMP50, HMP155, HM70, and HMI41.

An optional user output device 110 provides human readable output from the controller 106. In one example, the device 110 comprises a video monitor, LCD or CRT screen, or other device for the controller 106 to provide visible, human-readable output. Alternatively, or in addition, the device 110 may include speakers to generate human readable output in the form of sound. An optional user input device 112 is an apparatus to relay human input to the controller 106, and may comprise a mouse, trackball, voice input system, digitizing pad, keyboard, or such.

The controller 106 is further coupled to a library 118, which comprises machine-readable data storage. The library 118 includes listings of signatures 118a of hand gestures recognized by the system 100, and the corresponding commands 118b compatible with the machine 108.

In one example, each gesture and signature corresponds to one machine-readable command compatible with the machine 108. These commands appear in the listing of 118b. The commands 118b are cross-referenced against the signatures 118a by an index 118c. In the case of a personal computer, each command may include entry of one or multiple keyboard characters, mouse movements, a combination of keyboard and mouse movements, or any other appropriate computer input. In the case of another machine, each command may include any relevant machine-compatible command. For example, in the case of a model airplane remote control, the commands may include various inputs as to pitch, roll, yaw, and power. In the case of a video game that accepts input from a joystick, the machine-compatible commands may be up, down, left, right, and various button presses. The inventors contemplate many more arrangements, as well.

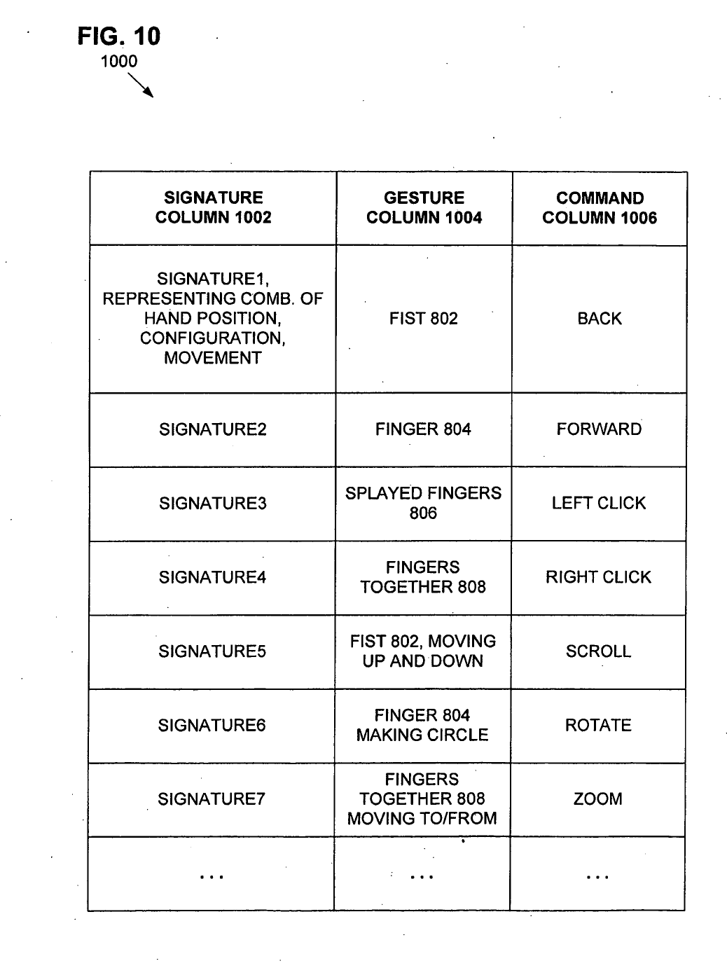

The foregoing, however, is merely one example of the data structure of the gestures and commands, as the library 118 may be configured in the form of a relational database, lookup table, linked list, or any other data structure suitable to the application described herein. FIG. 10, described below, illustrates an example of the library's contents.

### Exemplary Receiver Configuration

FIG. 1B shows an exemplary receiver configuration 140 in more detail. For greater perspective, the configuration 140 is shown relative to the user's hand 141. Referring to FIGS. 1A-1B, the emitter 146 is a relatively large, flat structure that emits an e-field 147. FIG. 1B shows the e-field 147 schematically, and in practice the direction and size of the e-field may vary considerably from this illustration. The receivers 142-143 in this example are rod-shaped structures, positioned above and to the sides of the emitter 146. The position of the hand relative to the receivers 142-143 is indicated by 144-145, which is indicative of the properties 103 of the e-field 147 detected by the receivers 104.

### More Detailed Example

### Gesture and Command Library

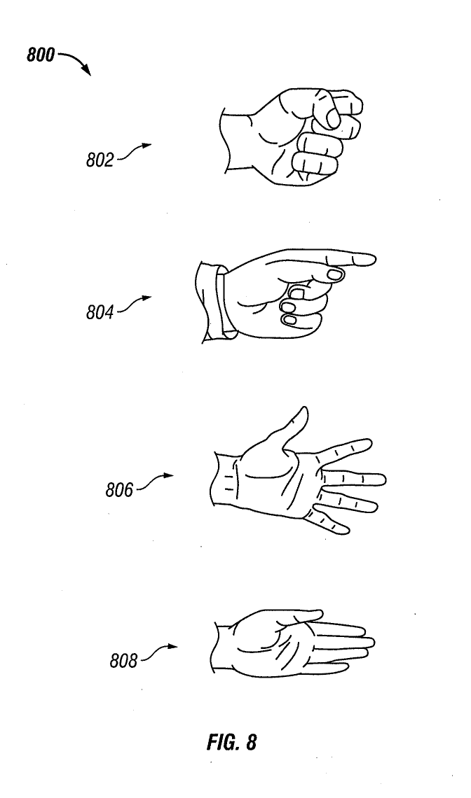

The gesture and command library is now described in greater detail with reference to FIGS. 8-10. As mentioned above, each gesture is a predefined combination of one or more of the following: hand presence or proximity to one or more of the emitters or the emitter field 115, hand position, hand configuration, hand movement. As to hand configuration, FIG. 8 provides examples of a fist 802, pointing finger 804, splayed fingers 806, and fingers together 808. Many more combinations are possible, of course. For example, with a suitable configuration of emitters 114 and appropriately sensitive receivers 104, the system 100 may recognize letters or words or both from a sign language such as American Sign Language.

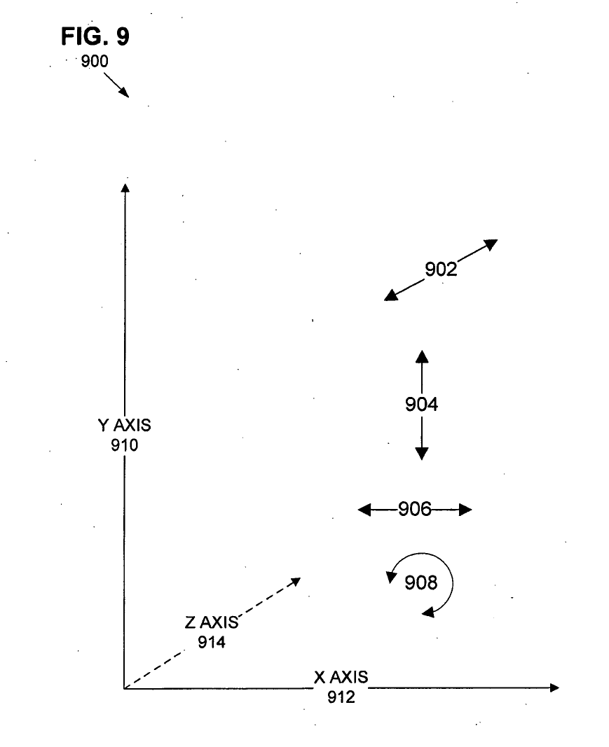

As to hand movement, FIG. 9 illustrates a Cartesian coordinate system 900 with an X axis 912, Y axis 910, and Z axis 914. Within this system are defined hand movements such as diagonal movement 902, up-down 904, left-right 906, and circling 908. Of course, the inventors further hand movements, and also contemplate using another appropriate coordinate system, such as Polar, instead of Cartesian.

FIG. 10 shows some exemplary contents of the library 118. Referring to FIGS. 1A and 10, the signatures 118a appear in column 1002. The machine-readable commands 118b appear in column 1006. The indexing 118c between columns 1002 and 1006 occurs, in this example, by way of the command and signature residing in the same row.

Each signature in column 1002 represents the signature corresponding to a given combination of hand position, proximity, configuration, and/or movement. The signature 1002 contained in the table 1000 may be the raw output of the receivers 104, the receiver output conditioned by the unit 105, or the conditioned output modified by further processing if desired. Accordingly, each signature may occur in the form of one or more of the following, or a variation of such: voltages, currents, capacitance, inductance, electrical resistance, EMF, electric power, electric field strength, magnetic field strength, magnetic flux, magnetic flux density, and the like. At any rate, each signature uniquely represents a particular hand gesture.

For each signature in column 1002, the gesture column 1004 identifies the corresponding hand gesture. The table 100 includes the column 1004 merely for ease of explanation, however, as the column 1004 may be omitted in the actual library.

As an alternative to FIG. 10, a different embodiment library 118 may serve to continuously translate the measured signature into an X-Y screen position for controlling a mouse. In this case, instead of a table, the library 118 may be implemented by applying a computational function to the measured signature to translate it into an X-Y cursor position, for example. As still another alternative, the library 118 may be configured so that some hand positions generate an x-Y screen position, whereas other hand positions generate discrete input commands.

### Exemplary Digital Data Processing Apparatus

As mentioned above, data processing entities, such as the controller 106, may be implemented in various forms. Some examples include a general purpose processor, digital signal processor (DSP), application specific integrated circuit (ASIC), field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

As a more specific example, FIG. 2 shows a digital data processing apparatus 200. The apparatus 200 includes a processor 202, such as a microprocessor, personal computer, workstation, controller, microcontroller, state machine, or other processing machine, coupled to a digital data storage 204. In the present example, the storage 204 includes a fast-access storage 206, as well as nonvolatile storage 208. The fast-access storage 206 may be used, for example, to store the programming instructions executed by the processor 202. The storage 206 and 208 may be implemented by various devices, such as those discussed in greater detail in conjunction with FIGS. 3 and 4. Many alternatives are possible. For instance, one of the components 206, 208 may be eliminated; furthermore, the storage 204, 206, and/or 208 may be provided on-board the processor 202, or even provided externally to the apparatus 200.

The apparatus 200 also includes an input/output 210, such as a connector, line, bus, cable, buffer, electromagnetic link, network, modem, transducer, IR port, antenna, or other means for the processor 202 to exchange data with other hardware external to the apparatus 200.

### Storage Media

As mentioned above, various instances of digital data storage may be used, for example, to provide storage used by the system 100 of FIG. 1, to embody the storage 204 and 208 of FIG. 2, etc. Depending upon its application, this digital data storage may be used for various functions, such as storing data, or to store machine-readable instructions. These instructions may themselves aid in carrying out various processing functions, or they may serve to install a software program upon a computer, where such software program is then executable to perform other functions related to this disclosure.

In any case, the storage media may be implemented by nearly any mechanism to digitally store machine-readable signals. One example is optical storage such as CD-ROM, WORM, DVD, digital optical tape, disk storage 300 (FIG. 3), or other optical storage. Another example is direct access storage, such as a conventional “hard drive”, redundant array of inexpensive disks (“RAID”), or another direct access storage device (“DASD”). Another example is serial-access storage such as magnetic or optical tape. Still other examples of digital data storage include electronic memory such as ROM, EPROM, flash PROM, EEPROM, memory registers, battery backed-up RAM, etc.

An exemplary storage medium is coupled to a processor so the processor can read information from, and write information to, the storage medium. In the alternative, the storage medium may be integral to the processor. In another example, the processor and the storage medium may reside in an ASIC or other integrated circuit.

### Logic Circuitry

In contrast to storage media that contain machine-executable instructions, as described above, a different embodiment uses logic circuitry to implement processing features such as the controller 106.

Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

FIG. 4 shows an example of logic circuitry in the form of an integrated circuit 400.

### Illustrative Example

By way of example, the following a more specific discussion of an exemplary gesture recognition system. This system translates human hand gestures or positions or movements into either keyboard characters one or multiple, or mouse movements, or both.

The system is implemented as an electronic logic printed circuit board physically, logically connected and powered by a personal computer via a standard USB interface. This circuit board is electrically connected to a “gesture field”, where the movements or positions or gestures of a human hand are detected. The logic board contains a microprocessor such as an Atmel™ brand AVR AT90USB with a USB interface, as well as the dedicated capacitance measurement integrated circuit such as an Analog Devices™ brand AD7746.

The microprocessor executes the software that emulates either a standard USB keyboard or USB mouse, or both. To the attached computer, the gesture input is no different than any other keyboard or mouse, so that existing device driver and application software can immediately work with the device. Optionally, software on the personal computer can control the characters returned for the keyboard emulation or the speed of the mouse movements, or both.

The gesture field comprises an emitter and two receivers. The emitter is a flat copper plate that is horizontally level on a table surface, while the two receivers are flat copper plates at ninety degrees to each other and are vertical in relationship to the emitter. The plates are electrically isolated from each other by mounting on non-conductive surfaces, but are in fixed spatial relationship to each other. These three plates are directly connected to a dedicated commercial capacitance measurement integrated circuit by a three wire interface, to allow the gesture field to move independently of the circuit board. In other implementations, the circuit board may be integrated along with the gesture field.

In this example, the device translates gestures or movements by a human hand to either mouse movements or keyboard characters. In one implementation, there are eight possible mouse movement directions or four possible keyboard characters. In a different design, there are at least sixteen different mouse movements and speeds, including eight directions with two speeds each, and eight keyboard characters are possible. The system may be adapted, without departing from this disclosure, to provide an even greater number of mouse movements and keyboard characters.

This system includes a number of further features. A dual channel capacitance measurement device with a single emitter and two receivers is used to determine the X-Y location or gesture of a human hand placed in the field between the receivers. The system translates the X-Y location to either keyboard characters or mouse movements. The system uses ranges of capacitance values, rather than single values, for translation into either keyboard characters or mouse movements. Optionally, software may be used to set the target character or characters into which detected gesture movements are translated, and to set the velocity of the mouse movements into which the gesture movements are translated.

An exemplary operational flow of the system is described as follows:
Software initializes hardware, zeroes out stray capacitance to normalize readings in both channels using the capacitance measurement integrated circuit features.
The system becomes ready to the personal computer through the USB interface. The personal computer then signals USB device connected via a predetermined series of audio tones.
Capacitance readings are taken at regular intervals based on USB polling from the computer. If a capacitance reading is taken different from the idle values, the readings are eligible for translation.
The X-Y location is translated into either mouse movements or characters unit by a lookup function of a previously determined set of ranges of capacitance.
If the X-Y location falls outside of the ranges, no character or movement is presented to the computer.
The X-Y location is a range, not a point. If the X-Y location translates successfully, the character or mouse movement is presented to the computer, an LED on the unit is illuminated, and a speaker attached to the unit is beeped.
A short delay is initiated to insure that only one valid reading occurs per gesture.
The foregoing process, beginning with the taking of capacitance readings, is performed repeatedly.

### Operation

Having described the structural features of the present disclosure, the operational aspect of the disclosure will now be described. The steps of any method, process, or algorithm described in connection with the embodiments disclosed herein may be embodied directly in hardware, firmware, in a software module executed by hardware, or in a combination of these.

### Overall Sequence of Operation

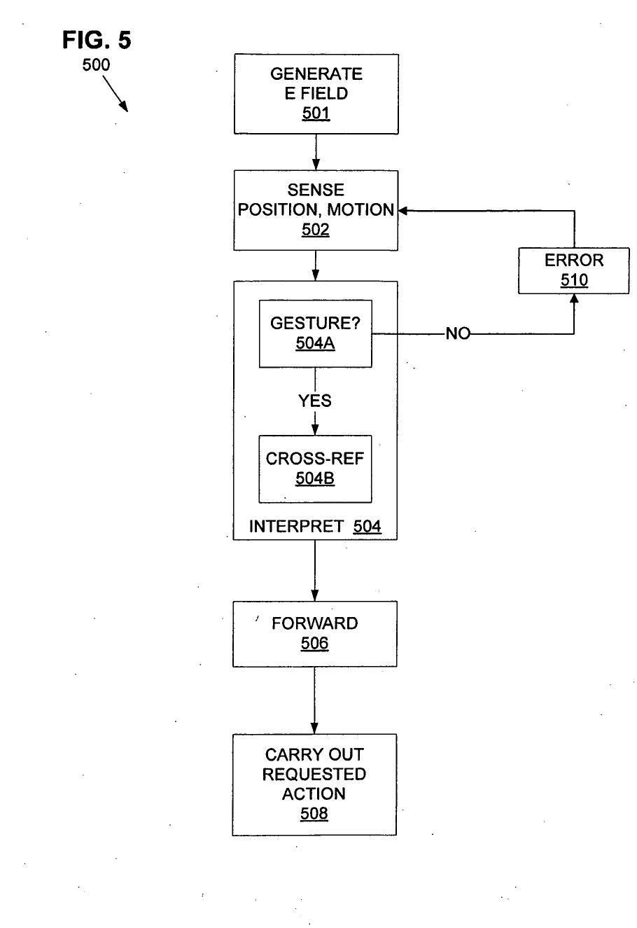

FIG. 5 shows a sequence 500 to illustrate one example of a method of controlling a machine using hand gestures. To provide some specific context, this is explained in the context of FIG. 1A, without any intended limitation. In step 501, the controller 106 directs the generators 116 to operate the emitters 114 to generate e-fields 115. The properties of the resulting fields 115 are appropriate to the shape and configuration of the emitters 114 and the electronics of the generators 116. This may be performed continuously, or the system may be activated upon user request, time schedule, regular time, or other stimuli.

In step 502, the receivers 104 sense the features 103 or properties or consequences of the e-field 115 under the presence, movement, and configuration of the hand 102 or hands. The receivers 104 may be activated or driven or powered by the controller 106, or they may automatically or continuously sense the features 103. In one example, each receiver 104 measures capacitive coupling between the emitter and that receiver. In a different example, the receivers 104 measure disturbance of the field 115. For instance, the receivers 104 may serve to measure the extent to which oscillators of the generators 116 are detuned. For each emitter-generator combination, this occurs to a different extent because of the different positional relationship of the emitter to the person's hand 102.

Also in step 502, the conditioning unit 105 processes the raw input from the receivers 104 and provides a representative signal to the controller 106. This is the signature corresponding to the hand 102's presence, configuration, and/or motion in the field 115. In one example, the unit 105 or the controller 106 triangulates signals from the receivers 104 to determine position and motion according to the X, Y, and Z axes 912, 910, 914. In addition to mere position, the controller 106 in this step may further calculate one or more motion vectors describing the motion of the user's hand in the field 115. Also in step 502, if the system 100 includes a humidity sensor 107, the controller 106 may condition the output of the unit 105 according to the measured humidity.

In step 504, the controller 106 interprets the signature. In step 504a, the controller 106 determines whether the current signature corresponds to a known gesture. In the embodiment of FIG. 10, this involves the controller 106 determining whether the current signature appears in column 1002 of the table 1000. Alternatively, in this operation, the controller may determine whether the current signature falls within a predetermined range.

If the answer to step 504a is NO, then in step 510 the controller 106 processes this condition by issuing an error message, or by prompting the user to perform the gesture again, or other appropriate action. In a further example, step 510 may ignore the activity of step 502, assuming that this corresponds to an errant gesture, an idle state, or another non-gesture.

On the other hand, if the answer to step 504a is YES, then the controller 106 in step 504b cross-references the current signature against the available commands to find the represented command. In the example of FIG. 10, the controller 106 indexes the current signature in column 1002 to find the corresponding command from column 1006. Alternatively, in step 504b the controller 106 applies a predetermined formula or other computation to the current signature to translate it into a continuously variable output, such as the screen position of a cursor.

In step 506, the controller 106 transmits the command from step 504b, or the continuously variable output, as input to the machine 108. Accordingly, in step 508, the machine 108 receives and acts upon the command from the controller 106. In this way, the user's hand gestures have the effect of controlling the machine 108.

### Training

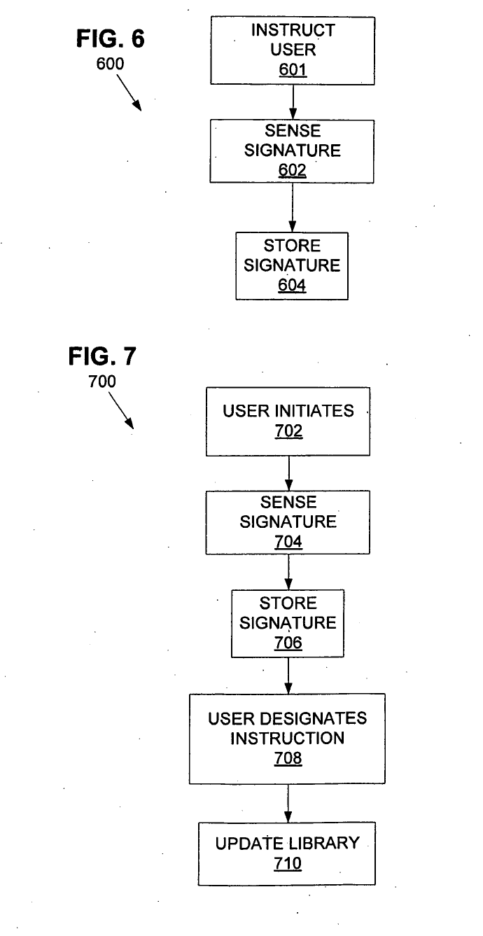

FIG. 6 shows an example of training the system 100. To provide some specific context, this is explained in the context of FIG. 1A, without any intended limitation. The routine 600 may be initiated automatically by the controller 106 or manually by the user. In step 601, the controller 106 operates the output device 110 to prompt the user to perform one of the recognized gestures, namely, a gesture from 1004. In step 602, the system 100 senses the signature while the user performs the requested gesture. This may include conditioning the receiver output according to output of one of the sensors 107, such as a humidity sensor. In step 604, the controller 106 stores the resultant signature in the library 118 in conjunction with the relevant gesture. In the example of FIG. 10, the controller 106 stores the signature in the column 1002 of table 1000. The controller 106 repeats the sequence 600 for each recognized gesture, or in other words, each gesture represented in the library 118.

Alternatively, the sequence may be selectively performed as needed, such as for problematic gestures. The sequence 600 therefore trains the system 100 to recognize gestures as performed by a particular user. By having the user perform a gesture, and then measuring the resultant signature, the system accounts for the variations that can occur from user to user, such as different hand sizes, hand humidity, manner of performing the gestures, and the like. In one example, the system 100 may repeat the training sequence for each user, as to each recognized gesture.

As an alternative to conducting training operations for each gesture, the system may instruct the user participate in a generalized calibration exercise, with instructions for the user to hold her hand proximate the receivers, close and open her hand, move around the extremes of the screen, and perform other relevant tasks. This may be part of training 600, a substitute for training, or a regular precursor to the operational sequence 500.

### Define New Gestures

FIG. 7 shows an example of adding a new gesture to the system 100. To provide some specific context, this is explained in the context of FIG. 1A, without any intended limitation. In this example, the user initiates the routine 700 in step 702. Also in step 702, the controller operates the output device 110 to prompt the user to perform the new gesture. In step 704, the system 100 senses the signature while the user performs the new gesture. In step 706, the controller 106 stores the resultant signature in the library 118 in conjunction with the new gesture. In the example of FIG. 10, the controller 106 stores the new signature in the column 1002 of table 1000.

In step 708, the controller 106 receives the user's designation of a machine-compatible command to be associated with the new gesture. This may occur, for example, by the user's input via the input device 112. In step 710, the controller 106 stores the user entered command in the library 118, indexed against the corresponding signature that was stored in step 706. In the particular example of FIG. 10, the controller 106 stores the command in column 1006, in the same row that contains the new gesture's signature from column 1002.

### Applications

The system 100 may be implemented in many different operational environments. One example is in a medical environment, where the system 102 relays human input to a machine without requiring the human to touch anything and violate a sterile or other sanitary environment. Among many other possible examples in this context, the machine 108 may be a dedicated x-ray viewer or a computer programmed to display x-rays. Other examples of the machine 108 include operating room equipment, dental equipment, equipment of a semiconductor clean room, equipment for examination rooms, blood and sperm bank equipment, laboratory measurement devices, and equipment for handling hazardous materials.

Although the following example does not require a sterile environment, the system 100 may applied to similar benefit in a restaurant or food service application. Here, the system relays touch-free human input while preserving cleanliness of a food preparation environment. The machine 108 in this context may include a cash register, kitchen appliance, food processing machine in a factory or kitchen setting, one or more machines in a manufacturing production line, telephone, point of sale system, recipe reference system, digital menus, tabletop infotainment centers, light switches, and such.

In a different example, the system 100 provides biometric security. Instead of a hand gesture, the system in step 504a evaluates the measured signature to determine any or all of: hand size, hand mass, hand moisture content, other physiological hand feature. Here, the system 100 determines whether the measured signature is present in the library 118, and only if so, activates a machine-controlled access point to permit access by the person. Alternatively, the system 100 may require other conditions before activating the access point, such as requiring advance permission of the user for this particular access point. The controlled machine 108 in this example may be a door lock, window lock, vehicle starting system, vault lock, gate controller, computer security system, or other secured asset.

In still another example, the system 100 may be applied to enforce pre-programmed safety criteria as to the operation of the machine 108. Here, the system 100 serves as a safety control module in conjunction with the machine 108, and the machine 108 constitutes a saw, drill, lathe, industrial machine, cutting machine, lawn or landscaping machine, automobile, or other equipment appropriate to this disclosure. In this example, due to the particular layout of the emitters 114, the e-fields 115 are generated in a prescribed configuration relative to the appliance 108 so that the receiver 104 can measure signatures caused by presence of a person's hand or hands proximate the machine 108. The system continually evaluates the signatures to determine if certain safety criteria are met. For example, this may include determining whether the person's hand occupies a prescribed position relative to the designated appliance or a feature of the designated appliance. For example, this may determine whether a person's hand is present at a designated handle, or whether the person's hand is moving toward a cutting surface. A different criteria is whether the person's hand lacks a prescribed minimum size or mass, which might indicate a child operator. If either of these criteria is met, the instruction relayed to the machine 108 in step 506 is a command to disable the machine 108.

In still another example, the system 100 constitutes a computer-driven handheld wireless telephone, and the controller 106 and machine 108 are one in the same. Here, the user's gestures are used in part or in whole to provide user input to the phone. Additionally, the system 100 analyzes the measured signature to determine if it matches a pre-programmed signature representing a person's head having a designated proximity with the telephone, for example, when a person places the phone to her ear. In this event, the system assumes that the user cannot control the phone with gestures while holding the phone to her ear. So, a machine-compatible instruction to disable gesture control operations is carried out while the phone is held to the user's ear.

The system 100 may be implemented in a variety of further applications, as shown by the following non-exclusive list:
Auto stereo and navigation controls.
Home entertainment, recliner control, television control, interactive furniture.
Home security, lighting, virtual combination locks.
Airplane seatback entertainment consoles/
Fly by wire control for aircraft or auto or wheelchair or scooters.
Industrial plant control.
Gambling machines, such as video poker or slot machines.
Playing altering the play of musical instruments, such as a guitar or synthesizer.
Interactive pornography and/or teledildonics.
Interactive toys.
Robotic control.
Kiosks providing services such as GPS, mall maps, soda machines, food dispensing, vending machines, ATM, self-checkout at supermarkets, bathroom, juke box.
Harsh environments, such as subzero, dirty, hazardous, or wet environments.
Computer accessibility for handicapped persons or those requiring use of a body part that cannot easily operate a keyboard.
Computer use such as word processing, spreadsheet, quick scrolling, card games, shooting games, mini-games, puzzles, 3D games, 3D virtual reality, perception-based 3D, tennis, karate or boxing, baseball, anything that involves hands, another idea is sensing entire body, movie editing, music editing, animation, graphics editing, photo editing, whiteboard drawing and manipulation.
Small handheld devices requiring an interface area that is larger than the device itself.

### Other Embodiments

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the invention, and the scope of the invention fully encompasses other embodiments which may become obvious to those skilled in the art, and that the scope of the invention is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC. 112, sixth paragraph, unless the element is expressly recited using the phrase “means for” or, in the case of a method claim, the phrase “step for.”

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the invention contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

1. A computer-implemented method for controlling a machine with hand gestures, comprising operations of:
generating one or more electromagnetic fields;
employing multiple receivers to measure an electromagnetic signature caused by gestures of a person's hand within the electromagnetic fields, the gestures including variations of any of hand position, hand configuration, and hand movement;
receiving measurements from at least one humidity sensor and normalizing the electromagnetic signature to account for variations in humidity;
for each measured signature, translating the normalized electromagnetic signature into a corresponding predefined machine-readable input; and
controlling a designated machine pursuant to the person's hand gestures by performing operations including: transmitting the identified input to the machine.

2. A computer-implemented method for controlling a machine with hand gestures, comprising operations of:
performing training operations including:
causing one or more emitters to generate one or more electromagnetic fields;
instructing a user to perform various predetermined hand gestures, the gestures including variations of any of hand position, hand configuration, and hand movement;
employing multiple receivers to measure one or more electromagnetic signatures caused by the gestures occurring within the electromagnetic field;
storing the measured electromagnetic signatures in a predetermined library in association with the instructed gesture and one or more machine-readable inputs;
controlling a designated machine according to user performed hand gestures, comprising:
causing the emitters to generate one or more electromagnetic fields;
employing the receivers to measure one or more electromagnetic signatures caused by gestures of a person's hand within the electromagnetic field, the gestures including variations of any of hand position, hand configuration, and hand movement;
identifying one or more corresponding machine-readable inputs by cross-referencing the measured signatures in said library or by applying a predetermined computational translation to the measured signatures; and
transmitting the identified input to the designated machine.

3. The method of claim 2, further comprising operations of:
responsive to user input initiating definition of a new gesture, performing operations comprising:
employing the receivers to measure one or more electromagnetic signatures caused by the new gesture of the person's hand within the electromagnetic fields;
storing the measured electromagnetic signature in the library;
receiving user designation of a machine-readable input associated with the new gesture, and storing the associated input in the library; and
configuring the library to associate the measured signature with the associated input.

4. A computer-implemented method of providing human input to a machine while maintaining medically sterile environment, comprising operations of:
providing a hands free gesture sensing computer control module in a medically sterile environment;
operating the module to perform operations comprising:
generating one or more electromagnetic fields;
employing multiple receivers to measure electromagnetic signatures caused by gestures of a person's hand or hands within the electromagnetic fields, the gestures including variations of any of hand position, hand configuration, and hand movement, and occurring while the person's hands remain free of contact with the module;
for each measured signature, identifying one or more corresponding machine-readable inputs by cross-referencing the measured signature in said library or by applying a predetermined computational translation to the measured signature; and
providing control input to a designated machine as dictated by the person's hand gestures by performing operations including:
transmitting the identified input to the machine.

5. The method of claim 4, where the machine is an x-ray image viewer.

6. A computer-implemented method of providing human input to a machine while preserving a sterile environment, comprising operations of:
providing a hands free gesture sensing computer control module in a sterile environment, the module including a computer connected to multiple receivers and at least one emitter;
operating the module to perform operations comprising:
causing the emitter to generate one or more electromagnetic fields;
employing the receivers to measure electromagnetic signatures caused by gestures of a person's hand or hands within the electromagnetic fields, the gestures including variations of any of hand position, hand configuration, and hand movement, and occurring while the person's hands remain free of contact with the module;
for each measured signature, identifying one or more corresponding machine-readable inputs by cross-referencing the measured signature in said library or by applying a predetermined computational translation to the measured signature; and
providing control input to a designated machine as dictated by the person's hand gestures by performing operations including:
transmitting the identified input to the designated machine; and
where the designated machine comprises the module or another machine.

7. A computer-implemented method of providing human input to a machine without violating sanitary conditions in a food preparation environment, comprising operations of:
providing a hands free gesture sensing computer control module in a restaurant, kitchen, factory, or other food preparation setting; and
operating the module to perform operations comprising:
generating one or more electromagnetic fields;
employing multiple receivers to measure electromagnetic signatures caused by gestures of a person's hand or hands within the electromagnetic fields, the gestures including variations of any of hand position, hand configuration, and hand movement, and occurring while the person's hands remain free of contact with the module;
for each measured signature, identifying one or more corresponding machine-readable inputs by cross-referencing the measured signature in said library or by applying a predetermined computational translation to the measured signature; and
providing control input to a designated machine as dictated by the person's hand gestures by performing operations including:
transmitting the identified input to the designated machine; and
where the designated machine is one of the following: a computer, a kitchen appliance, a food processing machine, one or more machines in a manufacturing production line, a cash register, a telephone.

8. A computer-implemented method of providing biometric security, comprising operations of:
generating one or more electromagnetic fields;
employing multiple receivers to measure at least one electromagnetic signatures caused by presence of a person's hand or hands in the electromagnetic field;
evaluating the electromagnetic signature to determine one or more of the following: hand size, hand mass, moisture content, or other physiological hand feature; and
determining whether the electromagnetic signature is present in a library of stored electromagnetic signatures;
only if the electromagnetic signature is present in the library and any other prescribed conditions are met, activating a machine-controlled access point to permit access by the person.

9. A computer-implemented method of regulating the operation of a designated appliance according to prescribed safety criteria, comprising operations of:
providing a safety control module in conjunction with a designated appliance; and
operating the module to perform operations comprising:
generating one or more electromagnetic fields in prescribed configuration relative to the designated appliance;
employing multiple receivers to measure at least one electromagnetic signature caused by presence of a person's hand or hands in the electromagnetic field;
evaluating the electromagnetic signature to determine one or more of the following: (1) if the person's hand occupies a prescribed position relative to the designated appliance or a feature of the designated appliance, or if the person's hand fails to occupy a different prescribed position relative to a feature of the designated appliance, (2) if the person's hand is smaller than a prescribed minimum size; and
if the evaluating operation answers YES, then disabling the appliance.

10. A computer-implemented method for operating a wireless telephone, comprising operations of:
generating one or more electromagnetic fields;
employing multiple receivers to measure electromagnetic signatures caused by one or more body parts of a person within the electromagnetic fields;
performing gesture control operations, comprising:
for each measured signature, cross-referencing the electromagnetic signature in a gesture library to determine if the signature corresponds to one of multiple predetermined gestures, each gestures including a different variation at least one of position, configuration, and movement of at least one hand or finger;
if the signature corresponds to one of the predetermined gestures, cross-referencing the predetermined gesture in a library to identify a corresponding predefined machine-readable input; and
controlling the telephone pursuant to the person's gestures by performing operations including: transmitting the identified inputs to the telephone for execution by the telephone;
additionally analyzing each measured signature to determine if the signature represents a person's head coming into designated proximity with the telephone; and
whenever a person's head comes into designated proximity with the telephone, disabling the gesture control operations.

11. A computer-implemented method for controlling a machine with hand gestures, comprising operations of:
operating a transmitter to generate an electromagnetic field;
operating a dual channel capacitance measurement device attached to multiple receivers to measure capacitive coupling between the transmitter and each of the receivers while a person performs one or more hand gestures within the electromagnetic field, the gestures including variations of any of hand position, hand configuration, and hand movement;
referencing a library containing different non-overlapping ranges of capacitance to identify one of said ranges containing said measured capacitive coupling, and further referencing the library to identify a prescribed machine-readable input corresponding to the identified range; and
controlling a designated machine pursuant to the person's hand gestures by performing operations including: transmitting the identified input to the machine for execution by the machine.

12. The method of claim 11, the operations further including:
initially operating the dual channel capacitance measurement device to measure idle capacitive coupling between the transmitter and each of the receivers without any hand gestures performed within the electromagnetic field; and
disabling the referencing and controlling operations whenever the measured capacitive coupling does not differ substantially from the idle capacitive coupling.

13. The method of claim 11, where the operations of referencing the library comprise one of the following: accessing a lookup table, applying a predetermined computational translation.

14. The method of claim 11, where the identified input comprises one of the following: a machine-readable instruction, a continuously updated cursor positioning input.
